(19) United States
(12) Patent Application Publication
(10) Pub. No.: US 2020/0059440 A1
(43) Pub. Date: Feb. 20, 2020

(54) COMMUNICATION DEVICE AND COMMUNICATION METHOD

(71) Applicant: FUJITSU LIMITED, Kawasaki-shi (JP)

(72) Inventors: Yuko Kukizono, Fukuoka (JP); Shinya Yamamura, Fukuoka (JP)

(73) Assignee: FUJITSU LIMITED, Kawasaki-shi (JP)

(21) Appl. No.: 16/533,960

(22) Filed: Aug. 7, 2019

(30) Foreign Application Priority Data
Aug. 16, 2018 (JP) 2018-153065

(51) Int. Cl. H04L 12/861; H04L 29/06

(52) U.S. Cl. CPC H04L 49/9005; H04L 67/42

(57) ABSTRACT

A communication device includes a memory, and a processor configured to, by dividing data transmitted from a first application to a second application in a period from opening to closing of a socket of the first application, perform generation of a plurality of pieces of divided data, common identification information being added to each of the plurality of pieces of divided data, and transmit the plurality of pieces of divided data to the second application.

### CROSS-REFERENCE TO RELATED APPLICATION

This application is based upon and claims the benefit of priority of the prior Japanese Patent Application No. 2018-153065, filed on Aug. 16, 2018, the entire contents of which are incorporated herein by reference.

### FIELD

The embodiments discussed herein relate to communication techniques.

### BACKGROUND

In recent years, wireless access points (hereinafter referred to as “APs”) have been widely spread. As a result of this, a style has become popular in which terminals such as smartphones perform communication while switching the connection between APs and wide-area wireless networks offered by communication carriers. In such an environment, the communication state is affected by the number of terminals connected and the radio conditions in the surroundings. As a consequence, the communication quality varies depending on a place and time and the communication is intermittent.

For example, there is a case where a user during travel performs communication with a server on the Internet while switching link target APs from one to another. In this case, if the data volume in the communication is large and the time for which the user stays in the link coverage area of the AP is short, the communication is disconnected halfway and the user has to redo the communication after a link with another AP is re-established.

To address this problem, there has been studied on the approach in which applications implemented in terminals and servers are made tolerant toward delays and disruptions in communication. For example, delay, disruption tolerant networking (DTN) is known as a technique enabling smooth communication even in an environment where the communication is intermittent. This technique has been standardized by the Internet Engineering Task Force (IETF), and for example, request for comments (RFC) 5050 defines a bundle protocol to be applied to the DTN.

When a connection between a terminal and a server is disconnected, for example, the DTN enables an operation in which data transmitted from the application of the terminal is temporarily stored dividedly in units called bundles, and then the bundles are transmitted to the server when the connection is reconnected. In the server, the data from the application of the terminal is restored from the bundles and passed to the application of the server.

For example, the related arts are disclosed in International Publication Pamphlet No. WO 2015/133055 and Japanese Laid-open Patent Publication No. 2014-60533.

### SUMMARY

According to an aspect of the embodiments, a communication device includes a memory, and a processor configured to, by dividing data transmitted from a first application to a second application in a period from opening to closing of a socket of the first application, perform generation of a plurality of pieces of divided data, common identification information being added to each of the plurality of pieces of divided data, and transmit the plurality of pieces of divided data to the second application.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a comparative example of communication between applications via DTN applications;

FIG. 2 is a configuration diagram illustrating an example of a terminal;

FIG. 3 is a configuration diagram illustrating an example of a server;

FIG. 4 is a configuration diagram illustrating examples of functional constituents of the terminal and the server;

FIG. 5 is a diagram illustrating a bundle format;

FIG. 6 is a diagram illustrating examples of a connection list, a filter table, and a bundle buffer;

FIG. 7 is a diagram illustrating an example of protocol conversion;

FIG. 8 is a flowchart illustrating an example of data transmission processing of a client application;

FIG. 9 is a flowchart illustrating an example of bundle transmission processing;

FIG. 10 is a flowchart illustrating an example of bundle reception processing;

FIG. 11 is a flowchart illustrating an example of switch processing of the applying of a bundle protocol;

FIG. 12 is a flowchart illustrating an example of stream output processing;

FIG. 13 is a diagram illustrating an example of processing of dividing application data into fragments;

FIG. 14 is a flowchart illustrating an example of stream input processing;

FIG. 15 is a diagram illustrating an example of application data restoration processing; and

FIG. 16 is a diagram illustrating an embodiment of communication between applications via DTN applications.

### DESCRIPTION OF EMBODIMENTS

The application data from the terminal is divided into bundles for each packet, which is a unit for transmission. Accordingly, in the server, the data for each packet is restored from the bundles and is passed to the application. Thus, the application data divided in the units of packets is passed to the application of the server.

For example, when the connection between the terminal and the server is disconnected for a long period of time, some of the packets may arrive at the server with a delay. In the related art, since packets having arrived at the server earlier have already been passed to the application of the server, the application of the server may detect an error because a timeout occurs in the communication period due to the reception of the incomplete data.

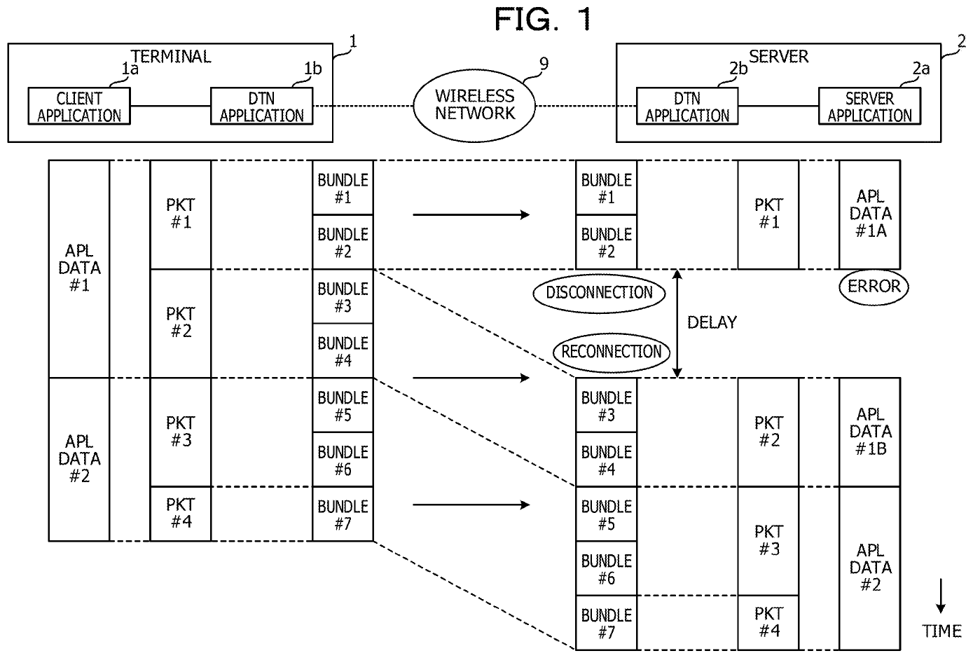

FIG. 1 is a diagram illustrating a comparative example of communication between applications via DTN applications 1b and 2b. A terminal 1 and a server 2 communicate with each other via a wireless network 9. The terminal 1 may be, for example, a communication device such as a smartphone or a personal computer, but is not limited to them.

In the terminal 1, a client application 1a and a DTN application 1b are implemented. In the server 2, a server application 2a and a DTN application 2b are implemented. The client application 1a and the server application 2a provide a user of the terminal 1 with various kinds of services by communicating with each other.

The client application 1a and the server application 2a communicate with each other without involving the DTN applications 1b and 2b in the case where the link between the terminal 1 and the server 2 is connected. When the link is disconnected, however, the client application 1a and the server application 2a communicate with each other via the DTN applications 1b and 2b.

According to the DTN bundle protocol, the DTN applications 1b and 2b act as proxies for the communication between the client application 1a and the server application 2a, and thus relay the communication. Hereinafter, description is provided for communication from the client application 1a to the server application 2a in the case where the link is disconnected.

The client application 1a transmits application data (APL data) #1 and #2 to the DTN application 1b. Each of the APL data #1 and #2 is a set of data to be used in a process of the server application 2a. For example, the server application 2a fails to execute a certain process unless all the APL data #1 is received, and fails to execute another process unless all the APL data #2 is received. In other words, the server application 2a fails to execute the processes when only parts of the APL data #1 and #2 are acquired.

In an example, the client application 1a transmits the APL data #1 dividedly in packets (PKT) #1 and #2, and transmits the APL data #2 dividedly in PKT #3 and PKT #4. PKT #1 to PKT #4 are, for example, Internet protocol (IP).

In an example, the DTN application 1b accommodates PKT #1 dividedly in bundles #1 and #2 and accommodates PKT #2 dividedly in bundles #3 and #4. Then, in an example, the DTN application 1b accommodates PKT #3 dividedly in bundles #5 and #6, and accommodates PKT #4 in a bundle #7.

The bundles #1 and #2 are transmitted to the server 2 when the link is reconnected. The DTN application 2b restores PKT #1 from the bundles #1 and #2 and transmits PKT #1 to the server application 2a. The server application 2a receives PKT #1 as APL data #1A which is a part of the APL data #1.

After that, when the link is again disconnected, the bundles #3 and #4 subsequent to the bundles #1 and #2 arrive at the server 2 with a delay. The DTN application 2b reproduces PKT #2 from the bundles #3 and #4 and transmits PKT #2 to the server application 2a. The server application 2a receives PKT #2 as APL data #1B which is the rest of the APL data #1.

However, since the server application 2a receives the incomplete APL data #1A prior to the reception of the APL data #1B, the server application 2a detects an error because a timeout occurs in the communication period. Hence, the server application 2a discards the APL data #1A and #1B and fails to execute the process using the APL data #1.

Then, the bundles #5 to 7 of the APL data #2 arrive at the server 2 without the link disconnected during the transmission. Hence, the DTN application 2b reproduces PKT #3 and PKT #4 from the bundles #5 to #7 and transmits PKT #3 and PKT #4 to the server application 2a. The server application 2a reproduces the APL data #2 from PKT #3 and PKT #4 and executes the process.

In this way, the server application 2a receives the APL data #1A and #1B divided in the units of packets from the DTN application 2b. For this reason, if the subsequent APL data #1B is received with a delay, a timeout occurs in the communication period due to the reception of the incomplete data, and consequently an error is detected.

To address this, the DTN application 1b of the terminal 1 divides data, which is transmitted by the client application 1a in a period from the opening to the closing of a socket, into multiple fragments and gives a common identification number to these fragments for the purpose of distinguishing between the APL data #1 and the APL data #2 for the respective processes of the server application 2a. Meanwhile, the DTN application 2b of the server 2 generates PKT #1 and PKT #2 from the fragments with the common identification number and forwards PKT #1 and PKT #2 to the server application 2a. Hereinafter, configurations of the terminal 1 and the server 2 are described.

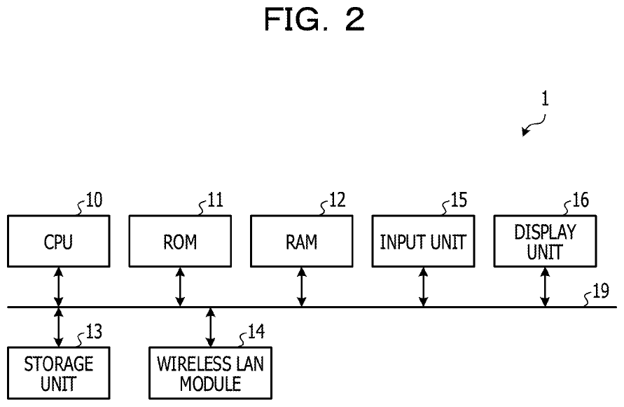

FIG. 2 is a configuration diagram illustrating an example of the terminal 1. The terminal 1 includes a central processing unit (CPU) 10, a read only memory (ROM) 11, a random access memory (RAM) 12, a storage unit 13 such as a hard disk drive (HDD) or a memory, a wireless local area network (LAN) module 14, an input unit 15, and a display unit 16. The CPU 10 is connected to the ROM 11, the RAM 12, the storage unit 13, the wireless LAN module 14, the input unit 15, and the display unit 16 via a bus 19 so as to enable mutual inputting/outputting of signals.

The ROM 11 has a program for driving the CPU 10 stored therein. The program in the ROM 11 includes a communication program for executing the communication method in an embodiment.

The RAM 12 functions as a working memory of the CPU 10. The storage unit 13 stores various kinds of information to be used for executing the program. The wireless LAN module 14 communicates with a server on the Internet by, for example, linking up with an AP connected to an access system network.

The input unit 15 is a means for inputting information to the terminal 1. Examples of the input unit 15 include keyboards, mice, and touch panels. The input unit 15 outputs the inputted information to the CPU 10 via the bus 19.

The display unit 16 is a means for outputting the information of the terminal 1. Examples of the display unit 16 include displays, touch panels, and printers. The display unit 16 acquires information from the CPU 10 via the bus 19 and displays the information. The display unit 16 displays the communication status and result of the client application 1a of the terminal 1, as described later.

When reading the program from the ROM 11, the CPU 10 forms various functions for executing the communication method. The CPU 10 is an example of a computer which executes the communication program. Note that the functional constituents of the terminal 1 are described later.

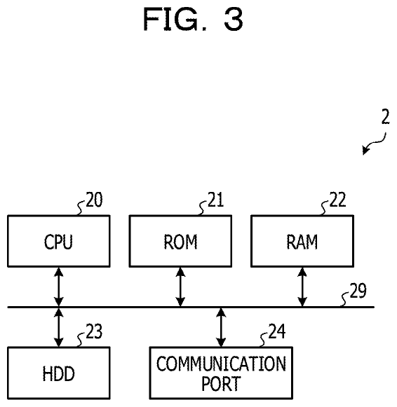

FIG. 3 is a configuration diagram illustrating an example of the server 2. The server 2 is, for example, a communication device that is connected to the Internet and that provides predetermined services by communicating with the terminal 1.

The server 2 includes a CPU 20, a ROM 21, a RAM 22, an HDD 23, and a communication port 24. The CPU 20 is connected to the ROM 21, the RAM 22, the HDD 23, and the communication port 24 via a bus 29 so as to enable mutual inputting/outputting of signals.

The ROM 21 has a program for driving the CPU 20 stored therein. The program in the ROM 21 includes a communication program for executing the communication method of the embodiment. The RAM 22 functions as a working memory of the CPU 20. The communication port 24 is, for example, a network interface card (NIC) and communicates with the terminal 1 via the Internet.

The CPU 20 forms various kinds of functions when reading the program from the ROM 21. The CPU 20 is an example of a computer which executes the communication program.

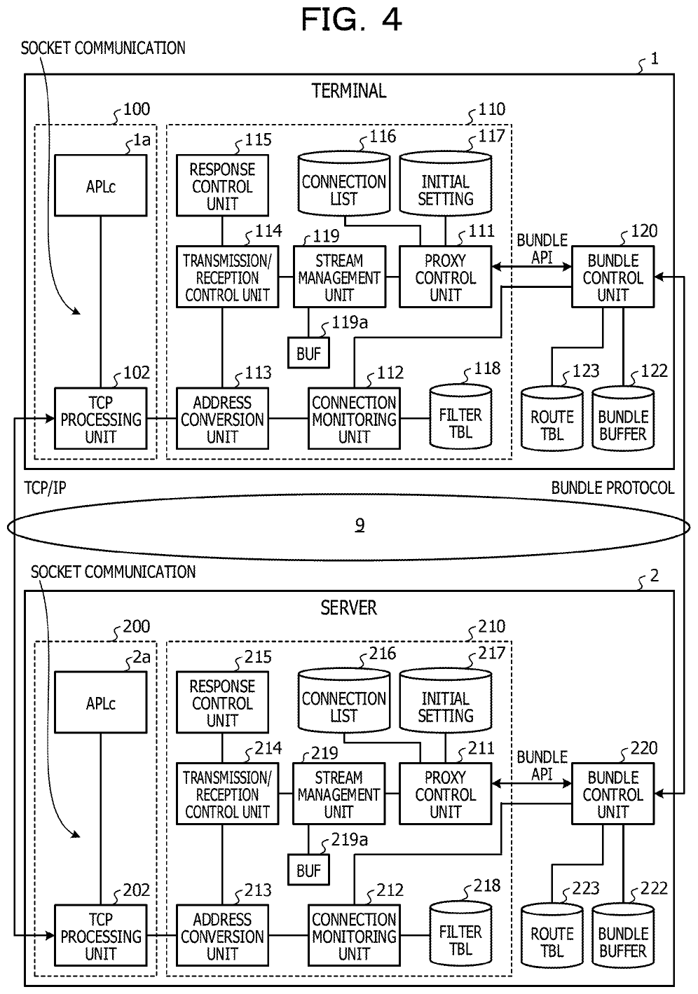

FIG. 4 is a configuration diagram illustrating examples of the functional constituents of the terminal 1 and the server 2. The terminal 1 and the server 2 are an example of a communication system, and are connected to each other via the wireless network 9. The following description is provided for an operation in the case where the terminal 1 transmits APL data to the server 2. However, an operation in the case where the server 2 transmits APL data to the terminal 1 is also the same as the operation described below, except that the transmission processing and the reception processing are reversed between the terminal 1 and the server 2.

The terminal 1 includes an application function unit 100, a proxy protocol function unit 110, a bundle control unit 120, a bundle buffer 122, and a route table (route TBL) 123.

The application function unit 100 includes a client application (APLc) 1a and a transmission control protocol (TCP) processing unit 102. The proxy protocol function unit 110 includes a proxy control unit 111, a connection monitoring unit 112, an address conversion unit 113, a transmission/reception control unit 114, a response control unit 115, a connection list 116, an initial setting file 117, a filter table (filter TBL) 118, and a stream management unit 119. The stream management unit 119 includes a buffer unit (BUF) 119a equipped with multiple buffers.

The client application 1a, the TCP processing unit 102, the proxy control unit 111, the connection monitoring unit 112, the address conversion unit 113, the transmission/reception control unit 114, the response control unit 115, the stream management unit 119, and the bundle control unit 120 are functions formed by the CPU 10 of the terminal 1. Meanwhile, the connection list 116, the initial setting file 117, the filter TBL 118, the bundle buffer 122, and the route TBL 123 are stored in the storage unit 13.

Note that the functional constituents of the terminal 1 illustrated in FIG. 4 excluding the application function unit 100 function as the communication device and the communication program of the embodiment, and constitute the DTN application 1b which relays the communication from the client application 1a to the server application 2a. The communication device and the communication program in an embodiment may be provided in the terminal 1 as in the present embodiment, but may be provided in a device other than the terminal 1.

On the other hand, the server 2 includes an application function unit 200, a proxy protocol function unit 210, a bundle control unit 220, a bundle buffer 222, and a route TBL 223.

The application function unit 200 includes a server application (APLs) 2a and a TCP processing unit 202. The proxy protocol function unit 210 includes a proxy control unit 211, a connection monitoring unit 212, an address conversion unit 213, a transmission/reception control unit 214, a response control unit 215, a connection list 216, an initial setting file 217, a filter TBL 218, and a stream management unit 219. The stream management unit 219 includes a buffer unit (BUF) 219a equipped with multiple buffers.

The server application 2a, the TCP processing unit 202, the proxy control unit 211, the connection monitoring unit 212, the address conversion unit 213, the transmission/reception control unit 214, the response control unit 215, the stream management unit 219, and the bundle control unit 220 are functions formed by the CPU 20 of the server 2. Meanwhile, the connection list 216, the initial setting file 217, the filter TBL 218, the bundle buffer 222, and the route TBL 223 are stored in the HDD 23.

Note that the functional constituents of the server 2 illustrated in FIG. 4 excluding the application function unit 200 function as the communication device and the communication program of the embodiment, and constitute the DTN application 2b which relays the communication from the client application 1a to the server application 2a. The communication device and the communication program in an embodiment may be provided in the server 2 as in the present embodiment, but may be provided in a device other than the server 2.

The server application 2a and the client application 1a communicate with each other via the TCP processing units 102 and 202 and provide predetermined functions in collaboration with each other. Examples of the functions of the server application 2a and the client application 1a include, but are not limited to, a file transfer function, a web browser function, and so on.

The TCP processing units 102 and 202 include, for example, TCP/IP communication functions provided by operating system (OS) drivers or the like. The TCP processing unit 102 of the terminal 1 transmits and receives packets by controlling the wireless LAN module 14, while the TCP processing unit 202 of the server 2 transmits and receives packets by controlling the communication port 24.

The server application 2a and the client application 1a perform direct communication based on TCP/IP when the link between the terminal 1 and the server 2 is established. However, in an environment where the link is unstable and the communication is intermittent, the bundle control units 120 and 220 perform communication based on the bundle protocol of DTN instead of the communication based on TCP/IP.

The bundle control unit 120 performs communication from the client application 1a to the server application 2a by switching from the communication based on TCP/IP to the communication based on the bundle protocol of DTN depending on the connection status with the server application 2a. Here, the connection monitoring unit 112 monitors the connection status with the server application 2a, and controls the address conversion unit 113 depending on the connection status.

Thus, the connection monitoring unit 112 switches the communication of the client application 1a from the communication based on TCP/IP to the communication based on the bundle protocol of DTN. As a result, the communication of the client application 1a is switched from the communication by the TCP processing unit 102 to the communication by the bundle control unit 120.

The bundle control unit 220 performs communication from the server application 2a to the client application 1a by switching from the communication based on TCP/IP to the communication based on the bundle protocol of DTN depending on the connection status with the client application 1a. Here, the connection monitoring unit 212 monitors the connection status with the client application 1a, and controls the address conversion unit 213 depending on the connection status.

Thus, the connection monitoring unit 212 switches the communication of the server application 2a from the communication based on TCP/IP to the communication based on the bundle protocol of DTN. As a result, the communication of the server application 2a is switched from the communication by the TCP processing unit 202 to the communication by the bundle control unit 220.

The bundle control units 120 and 220 perform communication based on the bundle protocol in accordance with, for example, the rules of RFC 5050. The bundle control units 120 and 220 accommodate transmission target data of the client application 1a and the server application 2a in a payload portion of a data message called a bundle, and transmit the transmission target data.

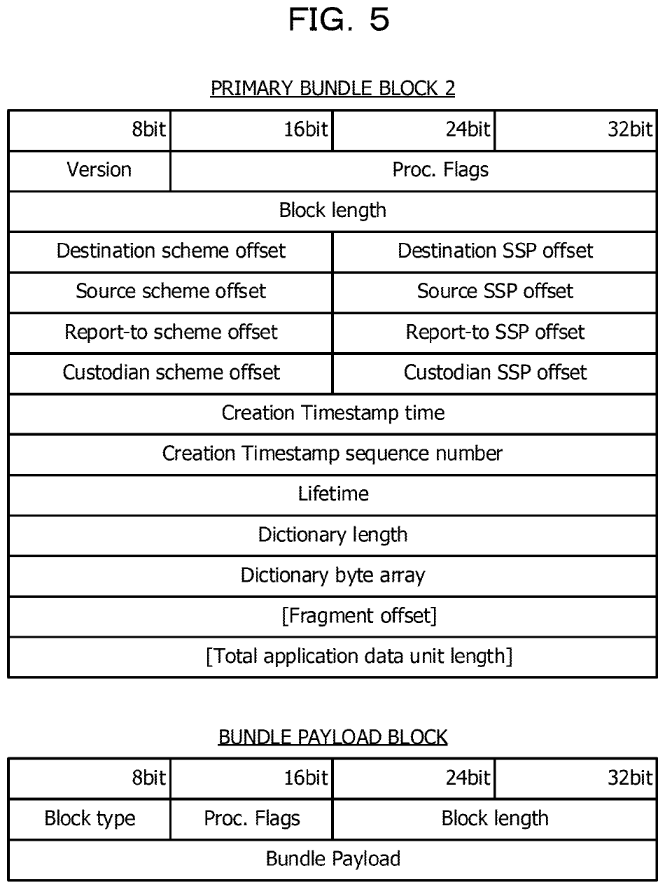

FIG. 5 illustrates a bundle format. The bundle includes a primary bundle block and a bundle payload block. The primary bundle block includes information on the transmission source and destination, the lifetime (“Lifetime”) indicating the time until bundle deletion, and the like. The bundle payload block includes a payload (“Bundle Payload”) for accommodating data. Note that each of the items in the bundle is specified in RFC 5050.

When transmitting a bundle, the bundle control units 120 and 220 refer to the route TBLs 123 and 223 to acquire the IP address and the TCP port number (hereinafter referred to as the “port number”) of the destination on the TCP/IP corresponding to the endpoint ID (EID) indicating the destination in the bundle protocol.

When the connection with the destination, that is, the connection between the terminal 1 and the server 2 is disconnected, the bundle control units 120 and 220 store bundles in the bundle buffers 122 and 222, and read and transmit the bundles from the bundle buffers 122 and 222 when the connection is reconnected. This causes communication based on the DTN. Note that the terminal 1 transmits and receives bundles by the bundle control unit 120 controlling the wireless LAN module 14, while the server 2 transmits and receives bundles by the bundle control unit 220 controlling the communication port 24.

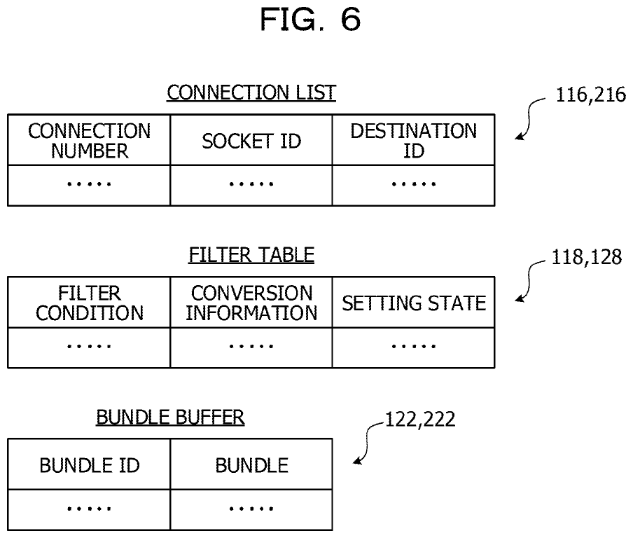

FIG. 6 illustrates an example of the bundle buffers 122 and 222. The bundle buffers 122 and 222 are bundle storage areas. Bundles are stored in the bundle buffers 122 and 222 together with the bundle IDs identifying the bundles. Note that the bundle control units 120 and 220 store bundles in the bundle buffers 122 and 222 not only when transmitting the bundles but also when receiving the bundles.

Referring to FIG. 4 again, the proxy protocol function units 110 and 210 convert the communication between the client application 1a and the server application 2a from TCP socket communication to bundle protocol communication. Here, the proxy protocol function units 110 and 210 set and control the bundle control units 120 and 220 in accordance with a bundle application programming interface (API), thereby enabling even common applications to use the DTN. Hereinafter, the details of the proxy protocol function units 110 and 210 are described.

The address conversion units 113 and 213 convert the communication destinations of the client application 1a and the server application 2a to addresses set in the transmission/reception control units 114 and 214. In the terminal 1, for example, the address conversion unit 113 converts the IP address and the port number of the destination of a packet having the server 2 as the destination to the IP address and the port number of the destination of the TCP socket (hereinafter referred to as the “socket”) set in the transmission/reception control unit 114.

Thus, the proxy protocol function units 110 and 210 may receive the data of packets transmitted from the client application 1a and the server application 2a to the communication destinations. Note that the address conversion units 113 and 213 are embodied by Windows Filtering Platform (WFP) when Windows (registered trademark) is used as the OS, and embodied by “iptables” when Linux is used as the OS, for example.

The transmission/reception control units 114 and 214 terminate the TCP socket communication of the client application 1a and the server application 2a. The transmission/reception control units 114 and 214 establish local loopback connections in the devices.

For example, the transmission/reception control unit 114 of the terminal 1 monitors the connection of a socket from the client application 1a, and obeys an instruction from the proxy control unit 111 to establish a socket for the server application 2a and transmit data to the designated socket.

The transmission/reception control unit 114 of the terminal 1 outputs packets received via the socket from the client application 1a to the stream management unit 119. The stream management unit 119 selects data transmitted in a period from the opening to the closing of the socket of the client application 1a from data transmitted from the client application 1a to the server application 2a, divides the selected data into multiple fragments, and gives a common sequence number (hereinafter referred to as “SN”) to the fragments. The fragments are an example of data pieces and the SN is an example of an identification number.

Meanwhile, the transmission/reception control unit 214 of the server 2 outputs packets received via the socket from the server application 2a to the stream management unit 219. The stream management unit 219 performs the same processing as the stream management unit 119 of the terminal 1. The stream management units 119 and 219 are examples of a data processing unit, and the client application 1a and the server application 2a are examples of first and second applications.

As described above, the stream management units 119 and 219 generate multiple fragments with a common SN from APL data. Thus, when receiving fragments, the terminal 1 and the server 2 is able to identify the APL data before division for each fragment based on the SN without analyzing the application-to-application communication protocol from the fragment.

For example, the stream management units 119 and 219 store the data of packets into the buffer units 119a and 219a, and thereby divide the data into fragments according to the size of each buffer in the buffer units 119a and 219a. Hence, a delay of a packet may be reduced by setting the size of the buffer to an appropriate value. The stream management units 119 and 219 output the fragments to the proxy control units 111 and 211.

The proxy control units 111 and 211 accommodate the fragments in the payloads of proxy messages and output the data to the bundle control units 120 and 220 with the bundles API. As a result, the bundle transmission is requested from the proxy control units 111 and 211 to the bundle control units 120 and 220.

The proxy control units 111 and 211 manage proxy messages with connection numbers corresponding to the destinations. Each time the socket is opened by the transmission/reception control units 114 and 214, the proxy control units 111 and 211 register a new connection number in the connection lists 116 and 216.

FIG. 6 illustrates an example of the connection lists 116 and 216. In the connection lists 116 and 216, the connection number, the socket channel ID, and the destination EID are registered in association with one another. The socket channel ID is an identifier of the socket of each of the transmission/reception control units 114 and 214.

The proxy control units 111 and 211 give the proxy message a connection number corresponding to the socket channel ID of the socket of the packet reception source and output the resultant proxy message to the bundle control units 120 and 220. In addition, the proxy control units 111 and 211 request the bundle control units 120 and 220 for bundle transmission to the corresponding destination EID. Thus, the EID of the server 2 is registered in the destination EID of the connection list 116 of the terminal 1, and the EID of the terminal 1 is registered in the destination EID of the connection list 216 of the server 2. Here, the proxy control units 111 and 211 read the initial setting files 117 and 217 to acquire information indispensable for communication such as the EIDs of the own devices and the EIDs of the communication destinations.

In addition, the proxy control units 111 and 211 receive proxy messages from the bundle control units 120 and 220. When the connection number of a received proxy message is unregistered in the connection lists 116 and 216, the proxy control units 111 and 211 instruct the transmission/reception control units 114 and 214 to open a new socket to start communication by the socket.

In addition, when data is not accommodated in the received proxy message, the proxy control units 111 and 211 search the connection lists 116 and 216 for the socket channel ID corresponding to the connection number of the proxy message. The proxy control units 111 and 211 instruct the transmission/reception control units 114 and 214 to delete the socket with the searched-out socket channel ID.

As described above, the socket and the EID are managed in association with each other by the connection lists 116 and 216. This makes it possible to perform TCP/IP communication using a socket based on the bundle protocol.

In addition, the bundle control units 120 and 220 transmit bundles in response to the bundle transmission request from the proxy control units 111 and 211. Thus, the bundle control units 120 and 220 are able to perform communication from the client application 1a and the server application 2a to the communication destinations based on the protocol of the disruption tolerant networking.

When the communication from the client application 1a and the server application 2a requires responses, the response control units 115 and 215 generate the responses and output the responses to the client application 1a and the server application 2a. Thus, the client application 1a and the server application 2a operate without knowing communication disruption even when the communication with the communication destination is disrupted due to the disconnection of the connection. Therefore, it is unnecessary to redo the communication after the reconnection of the connection.

For example, when the proxy control unit 111 performs communication of the client application 1a in the terminal 1, the response control unit 115 outputs a response to that communication to the client application 1a. In the case where the client application 1a transmits divides a file and transmits the divided data to the server application 2a, the response control unit 115 of the terminal 1 urges the client application 1a to transmit the next file data as a response instead of the server application 2a.

The connection monitoring units 112 and 212 monitor the connection status of the bundle control units 120 and 220. The connection monitoring units 112 and 212 establish connection while the connection is disconnected and, if the connection is successfully established, instruct the bundle control units 120 and 220 to transmit the transmission target bundles in the bundle buffers 122 and 222.

In addition, the connection monitoring units 112 and 212 set and delete the conversion information in the address conversion units 113 and 213 depending on the connection status. The connection monitoring units 112 and 212 set the conversion information based on the filter TBLs 118 and 218.

FIG. 6 illustrates an example of the filter TBLs 118 and 218. The filter condition, the conversion information, and the setting state of the packet are registered in the filter TBLs 118 and 218 in association with one another. The filter condition designates the IP addresses, the port numbers, and the like of the transmission source and the destination of the packet targeted for address conversion. The conversion information indicates the rewriting target section and the rewritten value of the packet which matches the filter condition. The setting state indicates validity or invalidity of settings of the filter condition and the conversion information.

The connection monitoring units 112 and 212 set or delete the conversion information in the address conversion units 113 and 213 depending on the connection status. Thus, the bundle protocol is automatically applied to communication of the client application 1a and the server application 2a.

As described above, the connection monitoring units 112 and 212 detect the connection status with the communication destination, and decide depending on the connection status whether or not to apply the bundle protocol to the communication of the client application 1a and the server application 2a. Thus, the bundle protocol is used for the communication of the client application 1a and the server application 2a depending on the connection status.

When the communication is intermittent, the client application 1a and the server application 2a communicate by TCP/IP protocol conversion using the above configuration.

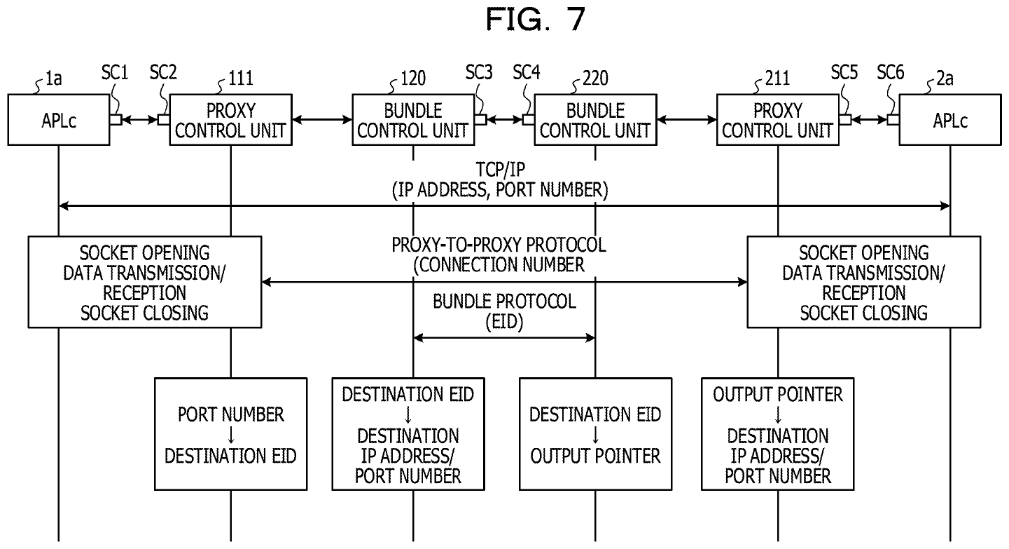

FIG. 7 illustrates an example of the protocol conversion. Among the constituents illustrated in FIG. 4, FIG. 7 illustrates the client application 1a, the proxy control unit 111, and the bundle control unit 120 of the terminal 1 as well as the server application 2a, the proxy control unit 211, and the bundle control unit 220 of the server 2.

TCP/IP communication using the IP addresses and the port numbers is performed between the client application 1a and the server application 2a. A certain socket SC1 is opened in the client application 1a, and a fixed socket SC6 is opened in the server application 2a.

Communication by the proxy-to-proxy protocol based on a connection number is performed between the proxy control units 111 and 211. For the proxy control unit 111, the transmission/reception control unit 114 opens a socket SC2 in one-to-one correspondence to the socket SC6 of the server application 2a. For the proxy control unit 211, the transmission/reception control unit 214 opens a socket SC5 in one-to-one correspondence to the socket SC1 of the client application 1a.

Communication by the sockets SC1 and SC2 is performed between the client application 1a and the proxy control unit 111, and communication by the sockets SC5 and SC6 is performed between the server application 2a and the proxy control unit 211. To this end, the transmission/reception control units 114 and 214 open and close the sockets SC2 and SC5 in conjunction with the sockets SC1 and SC6 of the client application 1a and the server application 2a, respectively, and perform data transmission/reception by the sockets SC2 and SC5.

The client application 1a transmits the APL data in units of packets in a period from the opening to the closing of the socket SC1. In the example of FIG. 1, PKT #1 and PKT #2 of the APL data #1 are transmitted in a period from the first opening to closing of the socket SC1, and PKT #3 and PKT #4 of the APL data #2 are transmitted in a period from the second opening to closing of the socket SC1.

Bundle protocol communication using the EIDs is performed between the bundle control units 120 and 220. Sockets SC3 and SC4 are opened in the bundle control units 120 and 220, respectively.

When communication from the client application 1a to the server application 2a is performed, the proxy control unit 111 in the terminal 1 converts the port number of the packet to the destination EID based on the initial setting file 117, and the bundle control unit 120 in the terminal 1 converts the destination EID to the IP address and the port number of the destination based on the route TBL 123.

In addition, the bundle control unit 220 in the server 2 converts the destination EID to an output pointer to be described later, and the proxy control unit 211 in the server 2 converts the output pointer to the IP address and the port number of the destination. As described above, the communication from the client application 1a to the server application 2a is performed. Hereinafter, processing to be executed in the communication is described.

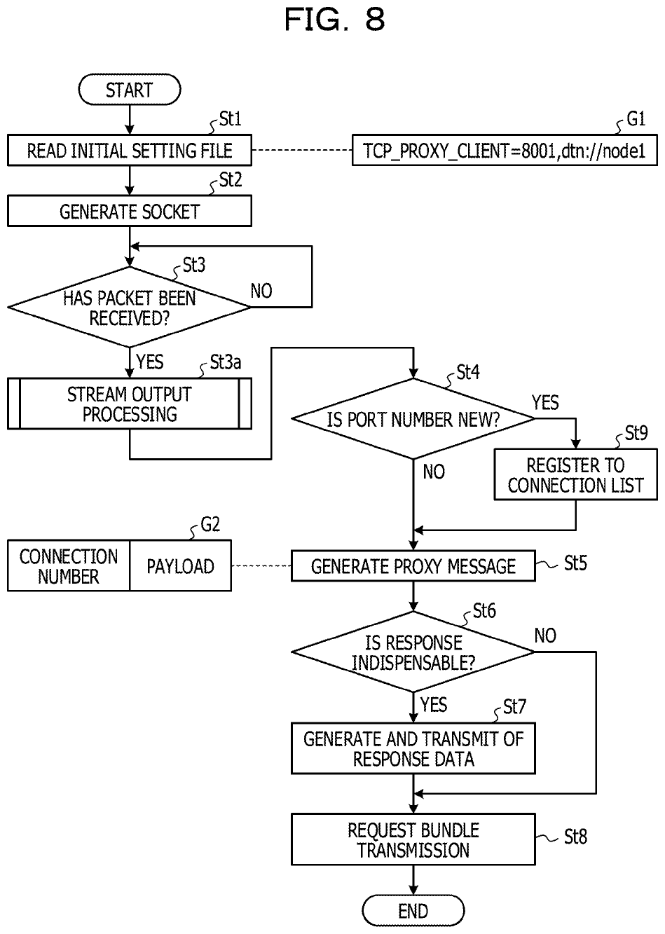

FIG. 8 is a flowchart illustrating an example of data transmission processing of the client application 1a. The proxy control unit 111 of the terminal 1 reads the initial setting file 117 denoted by the reference sign G1 (step SU). In the initial setting file 117, an EID “dtn://node1” of the terminal 1 is written as “TCP_PROXY_CLIENT”, and a port number “8001” for receiving, via TCP, packets addressed to the server application 2a as the communication destination.

Next, the proxy control unit 111 causes the transmission/reception control unit 114 to generate a socket for receiving packets addressed to the server application 2a from the client application 1a (step St2). Set in the socket is the above port number “8001” or a loop back IP address “127.0.0.1”. The client application 1a transmits a packet to the socket generated by the transmission/reception control unit 114 instead of the socket of the server application 2a. Here, the IP address and the port number of the destination of the packet are converted according to predetermined settings or by the address conversion unit 113.

Next, the transmission/reception control unit 114 determines whether or not a packet has been received in the socket (step St3). If no packet has been received (No in step St3), the transmission/reception control unit 114 executes again the determination process in step St3.

When a packet has been received (Yes in step St3), the transmission/reception control unit 114 divides the packet into fragments, and outputs the fragments to the stream management unit 119 to cause the stream management unit 119 to perform stream output processing (step St3a). Note that the details of the stream output processing are described later.

Subsequently, the proxy control unit 111 determines whether or not the port number of the transmission source of the packet is new (step St4). Specifically, the proxy control unit 111 determines whether or not the port number of the client application 1a has been changed to establish a new channel.

If the port number of the transmission source is new (Yes in step St4), the proxy control unit 111 registers a new connection number as well as the socket channel ID and the destination EID corresponding to that connection number in the connection list 116 (step St9). On the other hand, if the port number of the transmission source is not new (No in step St4), the proxy control unit 111 does not execute the process in step St9.

Next, the proxy control unit 111 generates a proxy message denoted by the reference sign G2 (step St5). The proxy message includes a connection number and a payload. The proxy control unit 111 generates the proxy message by accommodating fragments in the payload and giving the connection number retrieved from the connection list 116. The proxy message is outputted to the bundle control unit 120 with the bundle API.

Next, the response control unit 115 determines the necessity of a response for the packet to be transmitted (step St6). The response control unit 115 determines the necessity of a response for continuing the communication at the application level, not ACK of TCP.

If a response is indispensable (Yes in step St6), the response control unit 115 generates response data instead of the server application 2a based on a predetermined algorithm, and transmits the response data to the client applications 1a (step St7). Specifically, the response control unit 115 notifies the client application 1a of the completion of the communication. On the other hand, if a response is unnecessary (No in step St6), the response control unit 115 does not generate response data.

Next, the proxy control unit 111 requests, via the bundle API, the bundle control unit 120 for bundle transmission (step St8). The bundle control unit 120 generates bundles from the proxy message and transmits the bundles. Thus, the bundle control unit 120 performs the communication from the client application 1a to the server application 2a based on the protocol of the disruption tolerant networking. As described above, the data transmission processing of the client application 1a is executed.

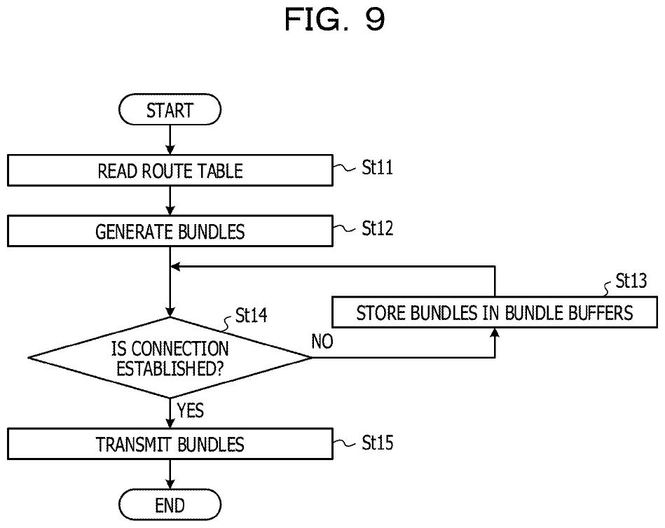

FIG. 9 is a flowchart illustrating an example of the bundle transmission processing. When requested for bundle transmission by the proxy control unit 111, the bundle control unit 120 reads the route TBL 123 (step St11). Next, based on the route TBL 123, the bundle control unit 120 generates a bundle for the destination EID corresponding to the IP address and the port number of the destination (step St12).

Next, the bundle control unit 120 determines whether or not the connection with the communication destination corresponding to the destination EID is established (step St14). If the connection is not established (No in step St14), the bundle control unit 120 stores the bundle in the bundle buffer 122 (step St13) and executes the process in step St14 again.

If the connection is established (Yes in step St14), the bundle control unit 120 transmits the bundle (step St15). As described above, the bundle transmission processing is executed.

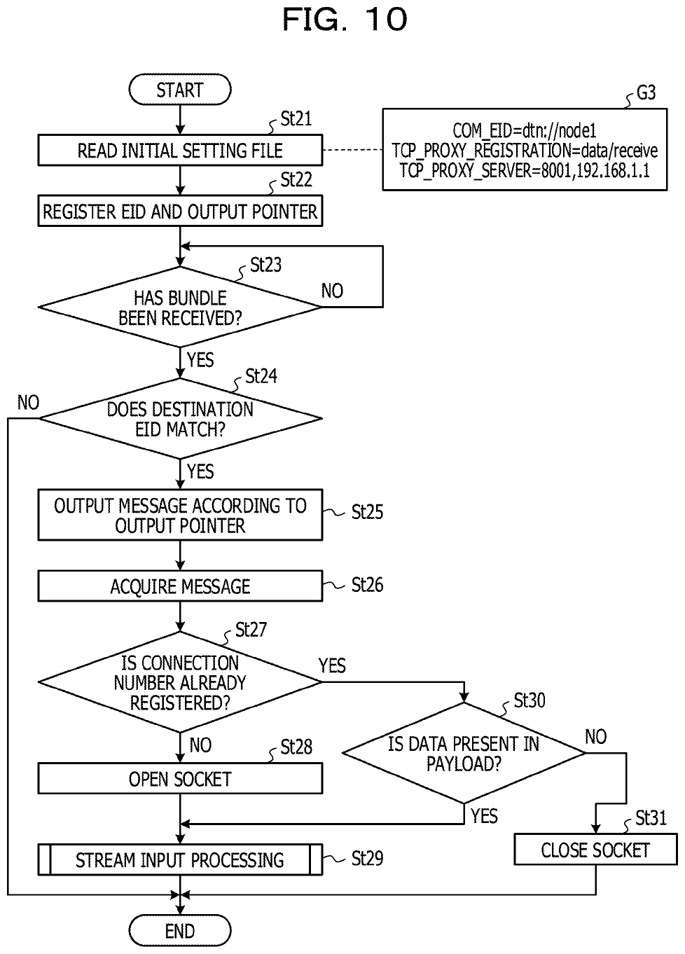

FIG. 10 is a flowchart illustrating an example of the bundle reception processing. This processing is executed by the server 2.

The proxy control unit 211 reads the initial setting file 217 denoted by the reference sign G3 (step St21). In the initial setting file 217, an EID “dtn://node1” of the server 2 is recorded as “COM_EID”, an output pointer “data/service” for received data in the server 2 is recorded as “TCP_PROXY_REGISTRATION”, and an IP address “192.168.1.1” and a port number “8001” of the server 2 are recorded as “TCP_PROXY_SERVER”.

Next, the proxy control unit 211 registers the EID and the output pointer in the bundle control unit 220 with the bundle API so that the bundle control unit 220 may receive a bundle from the client application 1a of the terminal 1 (Step St22). Here, the proxy control unit 211 registers the EID and the output pointer designated in “COM_EID” and “TCP_PROXY_REGISTRATION”, respectively, in the initial setting file 217. Thus, when receiving a bundle, the bundle control unit 220 outputs the bundle to the designated directory of the output pointer “data/receive”.

Next, the bundle control unit 220 determines whether or not a bundle has been received (step St23). If a bundle has not been received (No in step St23), the bundle control unit 220 executes the process in step St23 again. If a bundle has been received (Yes in step St23), the bundle control unit 220 determines whether or not the EID registered in step St22 and the destination EID of the bundle match (step St24).

If the registered EID and the destination EID of the bundle do not match (No in step St24), which means that the bundle is not a bundle addressed to the own device, the bundle control unit 220 discards the bundle and ends the processing. If the registered EID and the destination EID of the bundle match (Yes in step St24), the bundle control unit 220 acquires data from the payload of the bundle for generation of a proxy message to output the proxy message to the designated directory of the output pointer (step St25).

Next, the proxy control unit 211 refers to the designated directory of the output pointer to acquire the proxy message (step St26). The payload of the proxy message stores the fragment, and the proxy control unit 211 receives the fragment, as an example of a reception unit. Next, the proxy control unit 211 determines whether or not the connection number of the proxy message is registered in the connection list 216 (step St27).

If the connection number is unregistered (No in step St27), the proxy control unit 211 instructs the transmission/reception control unit 214 to open a socket with the IP address and the port number designated by “TCP_PROXY_SERVER” in the initial setting file 217 (step St28). On the other hand, if the connection number is registered (Yes in step St27), the proxy control unit 211 determines whether or not data is accommodated in the payload of the proxy message (step St30).

If the data is accommodated (Yes in step St30), the proxy control unit 211 inputs the data, that is, the fragments to the stream management unit 219, and thereby causes the stream management unit 219 to execute the stream input processing for outputting the packet from the corresponding socket to the server application 2a (step St29). In response to this, the stream management unit 219 generates the APL data from the fragments with the common SN, and transmits the APL data to the server application 2a. Note that the details of the data transmission processing is described later.

If the data is not accommodated (No in step St30), the proxy control unit 211 instructs the transmission/reception control unit 214 to close the corresponding socket (step St31). As described above, the bundle reception processing is executed.

As described above, the proxy protocol function units 110 and 210 open and close sockets for communication between the client application 1a and the server application 2a based on the operations of the applications, regardless of the link status between the terminal 1 and the server 2. This makes it possible to continue communication between the client application 1a and the server application 2a even if the connection is disconnected.

As described above, the connection monitoring units 112 and 212 set or delete the conversion information in the address conversion units 113 and 213 depending on the connection status. Thus, the bundle protocol is automatically applied to communication of the client application 1a and the server application 2a.

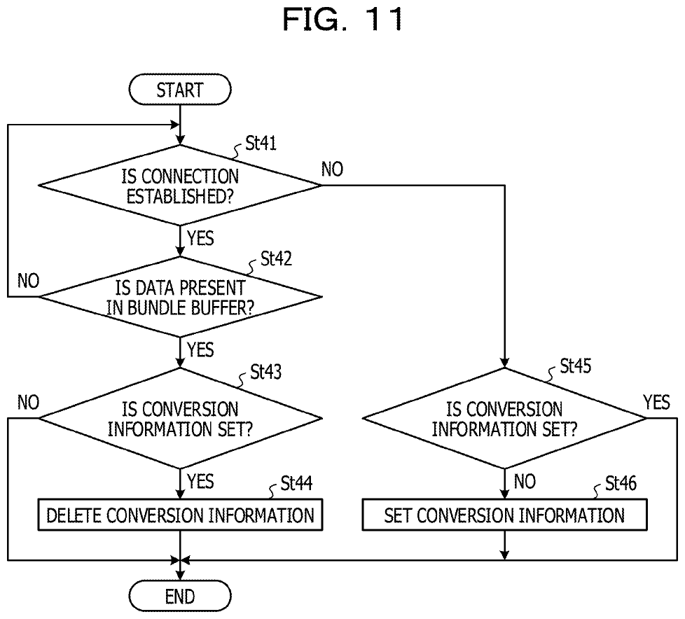

FIG. 11 is a flowchart illustrating an example of switch processing of the applying of the bundle protocol. The connection monitoring units 112 and 212 detect whether or not connection with the communication destination is established (step St41).

The bundle control units 120 and 220 detect the communication status using the keepalive function or the link-up/link-down with the corresponding communication destination based on the IP address and the port number of the destination set in the route TBLs 123 and 223. The connection monitoring units 112 and 212 acquire the detection results of the bundle control units 120 and 220 or detect the connection status by control with the bundle API or the like.

If the connection is established (Yes in step St41), the connection monitoring units 112 and 212 determine whether or not a bundle waiting for transmission is stored in the bundle buffers 122 and 222 (step St42). If no bundle is stored (No in step St42), the connection monitoring units 112 and 212 execute the process in step St41 again.

On the other hand, if a bundle is stored (Yes in step St42), the connection monitoring units 112 and 212 refer to the setting states of the filter TBLs 118 and 218 to determine whether or not the conversion information is set for the address conversion units 113 and 213 (step St43). If no conversion information is set (No in step St43), the connection monitoring units 112 and 212 end the processing. If the conversion information is set (Yes in step St43), the connection monitoring units 112 and 212 delete the conversion information (step St44).

This stops the forwarding of packets from the TCP processing units 102 and 202 to the sockets of the transmission/reception control units 114 and 214. As a result, the applying of the bundle protocol to the communication between the client application 1a and the server application 2a is stopped and the direct TCP/IP communication without involving the proxy protocol function units 110 and 210 is performed.

On the other hand, if the connection is disconnected (No in step St41), the connection monitoring units 112 and 212 refer to the setting states of the filter TBLs 118 and 218 to determine whether or not the conversion information is set for the address conversion units 113 and 213 (step St45). If the conversion information is set (Yes in step St45), the connection monitoring units 112 and 212 end the processing. If no conversion information is set (No in step St45), the connection monitoring units 112 and 212 set the conversion information (step St46).

This starts the forwarding of packets from the TCP processing units 102 and 202 to the sockets of the transmission/reception control units 114 and 214. As a result, the applying of the bundle protocol to the communication between the client application 1a and the server application 2a is started and the communication involving the proxy protocol function units 110 and 210 is performed.

As described above, the connection monitoring units 112 and 212 detect the connection status with the communication destination, and decide depending on the connection status whether to apply the bundle protocol to the communication between the client application 1a and the server application 2a. Thus, the bundle protocol is automatically applied.

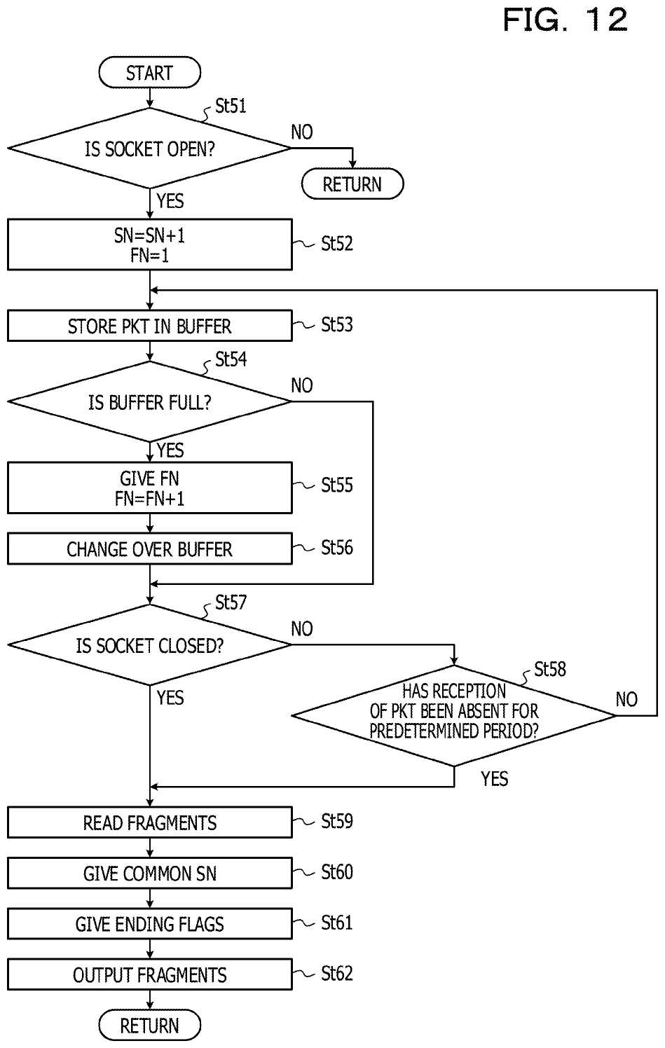

FIG. 12 is a flowchart illustrating an example of stream output processing. The stream output processing is executed in step St3a. Although the present embodiment is described for the processing of the stream management unit 119 of the terminal 1, the stream management unit 219 of the server 2 executes the same processing as the stream management unit 119.

The stream management unit 119 determines whether or not the socket SC1 of the client application 1a is open (step St51). If the socket SC1 is closed (No in step St51), the stream management unit 119 ends the processing.

If the socket SC1 is open (Yes in step St51), the stream management unit 119 adds 1 to the SN and sets the fragment number (hereinafter abbreviated to “FN”) to 1 (step St52). The FN is location information corresponding to the location of each of multiple fragments with a common SN in the APL data, and is used to arrange the fragments when the packets are reproduced from the fragments. Here, at the start-up of the terminal 1, the initial value of the SN is set to 1, for example.

Next, the stream management unit 119 stores the data in the packet, that is, the APL data transmitted from the socket SC1 by the client application 1a in a buffer of the buffer unit 119a (step St53). Then, the stream management unit 119 determines whether or not the buffer is full (step St54). If the buffer is not full (No in step St54), the stream management unit 119 executes the process in step St57 described later.

On the other hand, if the buffer is full (Yes in step St54), the stream management unit 119 gives FNs to the data in the buffer, that is, the fragments (step St55). Thus, the server 2 is able to restore the packet easily by identifying where each of the fragments received from the terminal 1 is to be located in the APL data. Next, the stream management unit 119 changes the data storage buffer to another buffer (step St56).

Then, the stream management unit 119 determines whether or not the socket SC1 of the client application 1a is closed (step St57). If the socket SC1 is not closed (No in step St57), the stream management unit 119 determines by using a timer whether or not the reception of a packet has been absent for a predetermined period (step St58). If a packet has been received for the predetermined period (No in step St58), the stream management unit 119 executes the processes in and after step St53 again.

If the socket SC1 is closed (Yes in step St57) or if a packet has not been received for the predetermined period (Yes in step St58), the stream management unit 119 reads the fragments from each of the buffers (step St59). Next, the stream management unit 119 gives a common SN to the fragments (step St60).

As a result, the fragments are given the SN corresponding to the APL data before division. Thus, the stream management unit 219 of the server 2 is able to identify the APL data before division for each fragment received from the terminal 1 without analyzing the application-to-application communication protocol from the fragment. In addition, the stream management unit 219 is able to restore all the packets into which the common APL data is divided and thereafter transmit the packets to the server application 2a. This inhibits incomplete data from being passed to the server application 2a, and thereby improves the stability of communication between the applications.

Subsequently, the stream management unit 119 gives an ending flag to each fragment (step St61). The ending flag indicates whether or not the fragment with the ending flag is located at the tail end of the APL data. An ending flag “1” indicates that the fragment is at the tail end, and an ending flag “0” indicates that the fragment is not at the tail end.

As described above, the stream management unit 119 gives the ending flag “1” to the fragment at the tail end in the APL data as information indicating the tail end. Thus, the stream management unit 219 of the server 2 is able to restore the complete APL data from the fragments by detecting the ending flag “1”, and transmit the packets to the server application 2a.

Next, the stream management unit 119 outputs the fragments to the proxy control unit 111 (step St62). As a result, the bundle control unit 120 accommodates the fragments in the bundles and transmit the bundles to the server application 2a. Note that the proxy control units 111 and 211 are examples of a transmission unit. As described above, the stream output processing is executed.

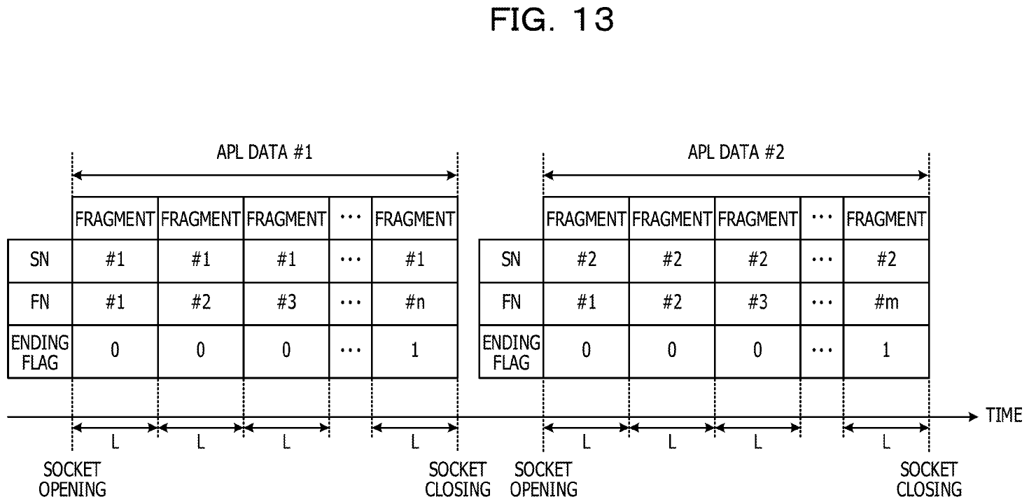

FIG. 13 illustrates an example of processing of dividing APL data into fragments. In FIG. 13, the right direction in the drawing is a direction in which the time advances. Although the present embodiment is described for the processing of the stream management unit 119 of the terminal 1, the stream management unit 219 of the server 2 divides APL data in the same way as the stream management unit 119.

The client application 1a transmits APL data #1 in a period from the opening to the closing of the socket SC1. The client application 1a transmits APL data #2 in the subsequent period from the opening to the closing of the socket SC1.

The stream management unit 119 divides the APL data #1 by buffer size L into n fragments (n: a positive integer), gives a common SN #1 to the fragments, and gives FN #1 to FN # n to the fragments sequentially from the top. Moreover, the stream management unit 119 gives the ending flag “1” to the fragment FN # n at the tail end of the APL data #1, and gives the ending flag “0” to the other fragments.

The stream management unit 119 divides the APL data #2 by buffer size L into m fragments (m: a positive integer), gives a common SN #2 to the fragments, and gives FN #1 to FN # m to the fragments sequentially from the top. Moreover, the stream management unit 119 gives the ending flag “1” to the fragment FN # m at the tail end of the APL data #2, and gives the ending flag “0” to the other fragments.

As described above, the SN, the FN, and the ending flag are given to each of the fragments. Thus, the stream management unit 219 of the server 2 is able to identify the APL data #1 or #2 before division for each fragment based on the SN and identify the location of each fragment in the APL data #1 or #2 based on the FN. In addition, the stream management unit 219 is able to confirm the reception of all the fragments into which APL data is divided by detecting the ending flag “1”.

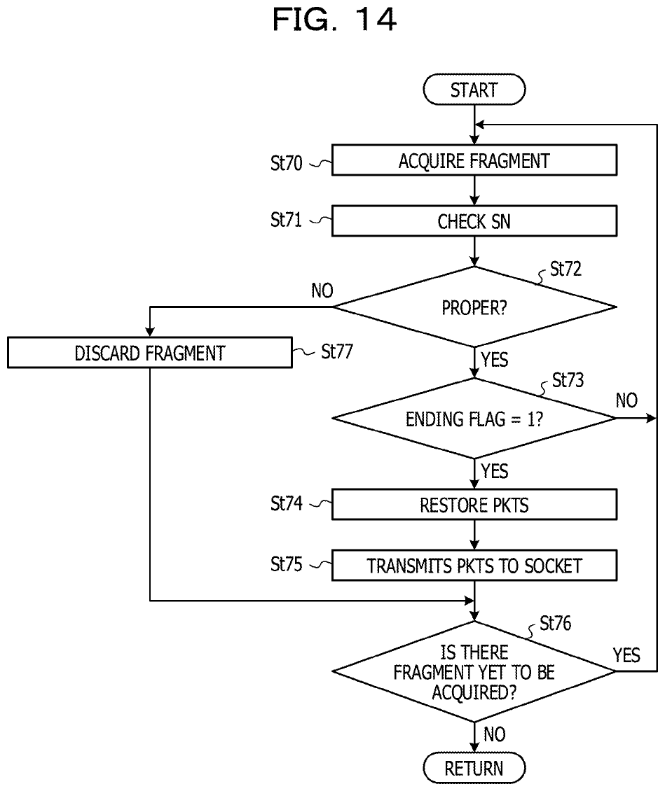

FIG. 14 is a flowchart illustrating an example of stream input processing. The stream input processing is executed in step St29. Although the present embodiment is described for the processing of the stream management unit 219 of the server 2, the stream management unit 119 of the terminal 1 executes the same processing as the stream management unit 219.

The stream management unit 219 acquires a fragment from a proxy message (step St70). The fragment is stored in the buffer of the buffer unit 219a.

Next, the stream management unit 219 checks whether the SN given to the fragment is proper or not (step St71). For example, the stream management unit 219 detects that the SN is improper in the case where the SN is not sequential from the previous SN or where the SN changes even if the fragment with the ending flag “1” is not received yet.

If the SN is improper (No in step St72), the stream management unit 219 discards the fragment (step St77). Then, the process in step St76 is executed.

On the other hand, if the SN is proper (Yes in step St72), the stream management unit 219 determines whether or not the ending flag given to the fragment is “1” (step St73). If the ending flag is “0” (No in step St73), the stream management unit 219 executes the processes in and after step St70 again.

On the other hand, if the ending flag is “1” (Yes in step St73), the stream management unit 219 restores the packets into which the common APL data is divided (step St74). In this process, the stream management unit 219 restores the packets by arranging the fragments with the common SN according to the FNs. Thus, the stream management unit 219 does not have to analyze the application-to-application communication protocol from each of the fragments.

Then, the stream management unit 219 transmits the packets from the transmission/reception control unit 214 to the socket SC6 of the server application 2a (step St75). Subsequently, the stream management unit 219 determines whether or not there is a fragment yet to be acquired from the proxy message (step St76).

If there is a fragment yet to be acquired (Yes in step St76), the stream management unit 219 executes the processes in and after step St70 again. Here, the SN of the fragment newly acquired increments by 1 from the previous SN.

If there is no fragment yet to be acquired (No in step St76), the stream management unit 219 ends the processing. As described above, the stream input processing is executed.

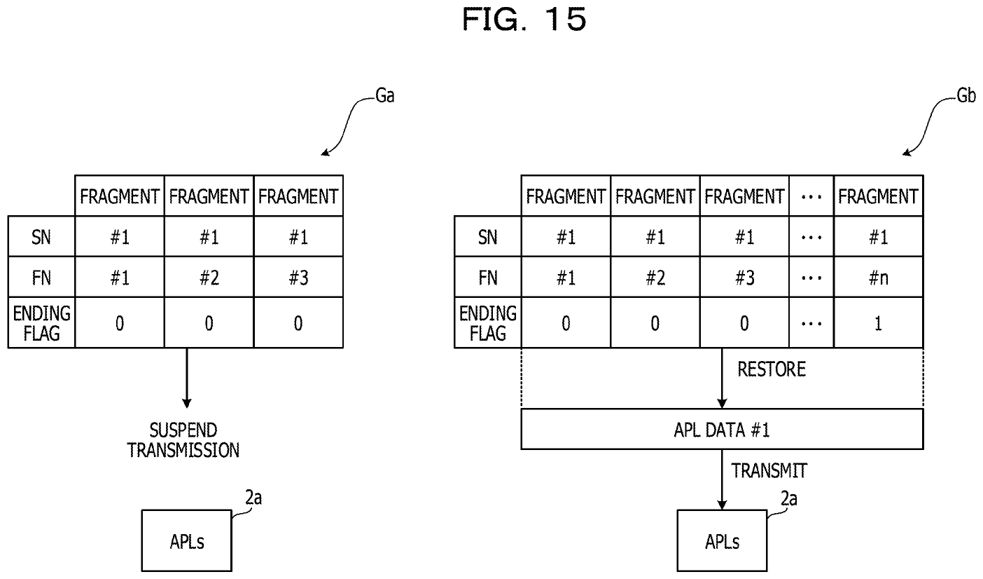

FIG. 15 is a diagram illustrating an example of APL data restoration processing. The reference sign Ga depicts an operation where the stream management unit 219 acquires only some of the fragments in the APL data #1, whereas the reference sign Gb depicts an operation where the stream management unit 219 acquires all the fragments in the APL data #1.

When the stream management unit 219 acquires only the fragments FN #1 to FN #3 among all the fragments with SN #1 into which the APL data #1 is divided, the stream management unit 219 waits while suspending transmission of the fragments FN #1 to FN #3 to the sever application 2a. Thus, the server application 2a does not receive the incomplete APL data #1 unlike the example in FIG. 1.

Moreover, when the stream management unit 219 acquires all the fragments (FN #1 to FN # n) of the APL data #1, the stream management unit 219 restores all the packets of the APL data #1 and transmits the packets to the server application 2a. This enables the server application 2 to receive the complete APL data #1, and reduces the occurrences of errors.

As described above, the stream management unit 219 generates APL data from fragments with a common SN among all the fragments received from the client application 1a, and transmits the APL data to the server application 2a. Thus, the stream management unit 219 is able to restore the APL data without analyzing the application-to-application communication protocol from the fragments, and pass the APL data to the server application 2a.

This makes it possible to reduce the occurrences of errors because part of APL data is inhibited from being passed to the server application 2a with a delay from the other part of the APL data. Thus, the stability of communication between the applications is improved.

In addition, the stream management unit 219 detects the fragment at the tail end in the APL data based on the ending flag “1” given to the fragment, generates the APL data after the detection, and transmits the APL data to the server application 2a. Thus, by detecting the ending flag “1”, the stream management unit 219 is able to confirm the reception of all the fragments into which the APL data is divided.

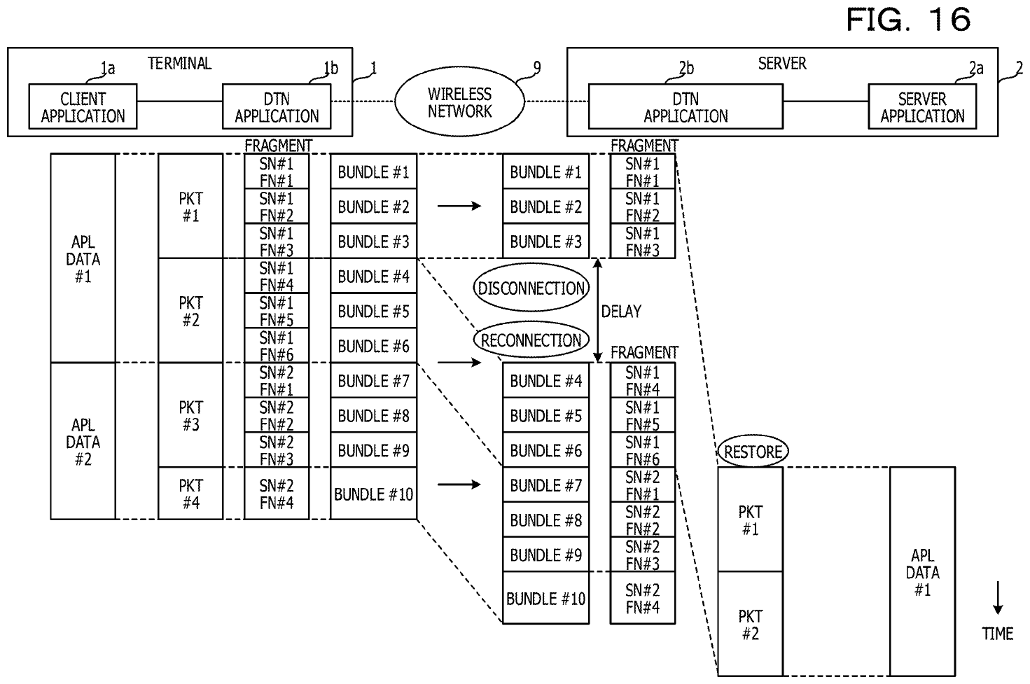

FIG. 16 is a diagram illustrating an embodiment of communication between the applications via the DTN applications 1b and 2b. In FIG. 16, constituents common to those in FIG. 1 are denoted by the same reference numerals, and description thereof is omitted. Note that the DTN application 1b has the functions of the terminal 1 illustrated in FIG. 4 excluding the application function unit 100, and the DTN application 2b has the functions of the server 2 illustrated in FIG. 4 excluding the application function unit 200.

The DTN application 1b of the terminal 1 divides PKT #1 and PKT #2, into which the APL data #1 is divided, into fragments FN #1 to FN #6. The fragments FN #1 to FN #6 are given a common SN #1 depending on the APL data #1.

The DTN application 1b accommodates the fragments FN #1 to FN #6 respectively into bundles #1 to #6, and transmits the bundles #1 to #6 to the server 2. In the present embodiment, one fragment is accommodated in one bundle as one example. However, the number of fragments accommodated in one bundle is not limited to this example, but is determined depending on the sizes of each bundle and each fragment.

Then, the DTN application 1b divides the subsequent APL data #2 into fragments (FN #1 to FN #4) with the SN #2, accommodates the fragments respectively into bundles #7 to #10, and transmits the bundles #7 to #10 to the server 2.

Meanwhile, the DTN application 2b of the server 2 first receives the bundles #1 to #3, thereafter encounters disconnection of the link, and then receives the bundles #4 to #10 after the link is reconnected. In this case, among the fragments with the SN #1, the fragments FN #4 to FN #6 arrive at the server 2 with a delay from the fragments FN #1 to FN #3.

However, when the DTN application 2b receives only the preceding fragments FN #1 to FN #3, the DTN application 2b suspends restoration of the PKT #1 and transmission of the PKT #1 to the server application 2a. In response to the acquisition of the remaining fragments FN #4 to FN #6, the DTN application 2b restores PKT #1 and PKT #2 of the APL data #1 and transmits PKT #1 and PKT #2 to the server application 2a.

Thus, according to the present embodiment, the complete APL data #1 is passed to the server application 2a. This inhibits a situation where the reception of the incomplete APL data #1 leads to the occurrence of a timeout and therefore the detection of an error. Moreover, although the present embodiment is described for the case where the client application 1a transmits the APL data #1 and #2 to the server application 2a, the processing for the case where the server application 2a transmits APL data to the client application 1a is the same as that described above except that the DTN applications 1b and 2b are reversed in their processing.

Additionally, it is possible to accomplish the processing functions described above using a computer. In that case, a program including multiple commands stating the processing contents of the functions to be possessed by a processing device is provided. Execution of the program with the computer achieves the processing functions described above on the computer. It is possible to store the program stating the processing contents in a computer-readable recording medium (excluding a carrier wave).

In the case of distributing a program, the program is sold in the form of, for example, a portable recording medium such as a digital versatile disc (DVD) or a compact disc read only memory (CD-ROM) containing the program recorded therein. Moreover, the program may be stored in a storage device of a server computer, and the program may be forwarded from the server computer to another computer via a network.

For example, the computer for executing the program stores in its own storage device the program recorded in the portable recording medium or the program forwarded from the server computer. Then, the computer reads the program from its own storage device to execute the processing in accordance with the program. Note that the computer may read the program directly from the portable recording medium to execute the processing in accordance with the program. Furthermore, the computer may sequentially execute the processing in accordance with the received program each time the program is forwarded from the server computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication device comprising:
a memory; and
a processor coupled to the memory and the processor configured to
by dividing data transmitted from a first application to a second application in a period from opening to closing of a socket of the first application, perform generation of a plurality of pieces of divided data, common identification information being added to each of the plurality of pieces of divided data, and
transmit the plurality of pieces of divided data to the second application.

2. The communication device according to claim 1, wherein
the generation includes adding information indicating an end of the data to a last piece of divided data in the plurality of pieces of divided data.

3. The communication device according to claim 1, wherein
the dividing includes storing the data into a buffer and dividing the data in accordance with a size of the buffer.

4. The communication device according to claim 1, wherein
the generation includes adding location information to each of the plurality of pieces of divided data, the location information indicating each position of the plurality of pieces of the divided data piece in the data.

5. A communication device comprising:
a memory; and
a processor coupled to the memory and the processor configured to
receive a plurality of pieces of divided data generated by dividing data transmitted from a first application to a second application,
perform generation of the data by combining the plurality of pieces of divided data based on identification information included in each of the plurality of pieces of divided data, and
transmit the generated data to the second application.

6. The communication device according to claim 5, wherein
the generation is performed in response to detecting, from the plurality of pieces of divided data, a piece of divided data to which information indicating an end of the data is added.

7. The communication device according to claim 5, wherein
the data is transmitted from the first application the second application in a period from opening to closing of a socket of the first application.

8. The communication device according to claim 5, wherein
each of the plurality of pieces of divided data includes location information indicating each position of the plurality of pieces of divided data in the data.

9. A computer-implemented communication method comprising:
by dividing data transmitted from a first application to a second application in a period from opening to closing of a socket of the first application, generating a plurality of pieces of divided data, common identification information being added to each of the plurality of pieces of divided data; and
transmitting the plurality of pieces of divided data to the second application.

10. The communication method according to claim 9, wherein
the generating includes adding information indicating an end of the data to a last piece of divided data in the plurality of pieces of divided data.

11. The communication method according to claim 9, wherein
the dividing includes storing the data into a buffer and dividing the data in accordance with a size of the buffer.

12. The communication method according to claim 9, wherein
the generating includes adding location information to each of the plurality of pieces of divided data, the location information indicating each position of the plurality of pieces of the divided data piece in the data.
